(19) United States
(12) Patent Application Publication
(10) Pub. No.: US 2006/0114990 A1
(43) Pub. Date: Jun. 1, 2006

(54) Method and apparatus for efficiently transmitting scalable bitstream

(75) Inventor: Seong-joon Pak, Seoul (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/271,986

(22) Filed: Nov. 14, 2005

Related U.S. Application Data
(60) Provisional application No. 60/630,660, filed on Nov. 26, 2004.

(30) Foreign Application Priority Data
Jan. 6, 2005 (KR) 10-2005-0001304

(51) Int. Cl. H04N 11/04; H04B 1/66; H04N 11/02; H04N 7/12

(52) U.S. Cl. 375/240.03; 375/240.1

(57) ABSTRACT

A method and apparatus for transmitting a scalable bitstream after packetizing the scalable bitstream into packets according to priority to fully utilize a bandwidth in a variable network environment are provided. The apparatus includes a bit adjuster extracting some layers from a number of frames contained in the scalable bitstream according to a scanning order, a streaming unit packetizing bits in the extracted layer to match a currently available bandwidth, and a bandwidth estimator estimating the currently available bandwidth.

### CROSS-REFERENCE TO RELATED APPLICATION

This application claims priority from Korean Patent Application No. 10-2005-0001304 filed on Jan. 6, 2005 in the Korean Intellectual Property Office, and U.S. Provisional Patent Application No. 60/630,660 filed on Nov. 26, 2004 in the United States Patent and Trademark Office, the disclosures of which are incorporated herein by reference in their entirety.

### BACKGROUND OF THE INVENTION

1. Technical Field

The present invention relates to a method for efficiently transmitting a scalable bitstream, and more particularly, to a method and apparatus for transmitting a scalable bitstream after packetizing the scalable bitstream into packets according to priority so as to fully utilize a bandwidth in a variable network environment.

2. Related Art

The growth of the Internet and the emergence of digital content has resulted in the use of related art Internet video streaming applications. For a network having sufficient bandwidth, audio/video compression codec with a high compression ratio may be used to transmit data. However, for a network having rapidly varying bandwidth such as the Internet, a compression method that can actively adapt to varying bandwidth is urgently needed.

In applications such as video conferencing that permit real-time encoding and one-to-one video communication, the size of encoded data can be adjusted by adjusting encoding parameters according to network situations. On the other hand, a related art video compression method suffers many limitations when streaming data is transmitted to a plurality of clients having different bandwidths. To overcome these limitations, a related art scalable video coding method that allows a single encoded bitstream to be decoded at different bit-rates has been proposed. The scalable video coding technique provides video representation in a flexible bitstream format.

Scalability is the ability to generate video data at different bit-rates by extracting a part of bitstream instead of decoding encoded video data. The major types of scalability are spatial scalability (i.e., the ability to generate videos at different spatial resolutions), signal to noise ratio (SNR) scalability (i.e., the ability to generate videos at various qualities), temporal scalability (i.e., the ability to generate videos at different frame rates), and a combination of two or more of these scalabilities.

The related art includes Moving Picture Experts Group (MPEG)-4 standardized fine granular scalability (FGS) as well as traditional single bit-rate video compression schemes. Although much research has been conducted into a method for improving FGS coding efficiency, less attention has been directed to a method for improving the use of bandwidth when a FGS-based video bitstream is transmitted over the Internet having temporally varying bandwidth.

However, to improve the visual quality of a FGS video bitstream received by a video decoder, additional research into efficient transmission of a bitstream and research into improvement of coding scheme is needed. The video decoder reconstructing a video stream can be understood as a client device receiving a video streaming service.

FIG. 1 shows transmission priority typically used for a stream server to transmit a scalable bitstream. The ordinate and abscissa in FIG. 1 denote a bit-plane coded bitstream arranged from a base layer to a high layer, and frames arranged in the temporal order, respectively. BL and BP respectively denote a base layer and a high layer or high bit-plane. In the related art, a maximum number of bits allowable within the present bandwidth are transmitted in the order of a base layer bitstream to a high layer bitstream making up a frame.

In related art scalable coding schemes, the amount of data in a base layer is substantially less than that in a high layer. Furthermore, when the base layer is lost, media data cannot be decoded using only the high layer. Thus, research is being conducted into a method for improving transmission efficiency by inserting an error correction code into the base layer.

FIG. 2 illustrates a related art method for extracting a scalable bitstream according to a variable network bandwidth. Here, “#A-B BP” and “#C BL” respectively denote a B-th enhancement layer (or bit-plane) in an A-th frame and a base layer in a C-th frame.

To run a related art stream server transmitting the scalable bitstream, media data must be compressed into a scalable bitstream using scalable coding. A streaming server extracts a scalable bit-stream at a bit-rate required according to information about network bandwidth measured in real time. A scalable bitstream extracted according to a bit-rate suitable for a network bandwidth is packetized into packets and transmitted over a network. In this case, the stream server extracts a bitstream commensurate with a bandwidth. A low layer (base layer) is assigned the highest priority on a low layer (base layer) in each frame.

In FIG. 2, an upper dotted line indicates a currently available bandwidth, and the ordinate and abscissa denote a frame number of a video sequence and the number of bits in each frame. Since the size of a bitstream increases toward an enhancement layer, the available bandwidth is not sufficient to accommodate the next entire bit-plane, thus resulting in a waste of bandwidth. In frame 5 and frame 9, up to only a second bit-plane can be transmitted due to low bandwidth at that moment.

Related Art MPEG-4 FGS video streaming has a drawback in that it has low efficiency in channel use. Because the size of bitstream increases toward the high bit-plane portion of the enhancement layer shown in FIG. 2, the high bit-plane tends to drop so that a FGS bitstream may be streamed over a channel at a rate lower than the available bandwidth. Furthermore, when the channel bandwidth rapidly changes, the number of bit-planes in a frame received by a video decoder varies significantly. This results in a momentary change in the quality of a reconstructed frame and a flickering effect in a reconstructed video sequence.

Another drawback of the related art MPEG-4 FGS video streaming is that it cannot ensure the transmission of a base layer bitstream (i.e., the minimum requirement for reconstructing a frame at a video decoder) when channel bandwidth rapidly decreases. In this case, the video decoder cannot reconstruct a frame corresponding to the base layer bitstream. When the frame is an I- or P-frame that is used as a reference frame, neither the I-frame (P-frame) nor a frame encoded with reference to the I- or P-frame can be reconstructed.

Yet another drawback is that unnecessary, repetitive burdensome search is needed for a stream server to parse a scalable compressed bitstream frame by frame and bit-plane by bit-plane, and to extract a layer upon request from a client.

### SUMMARY OF THE INVENTION

The present invention provides a method for reducing the complexity of a streaming media server transmitting a scalable bitstream by generating an index file for a specific bitstream.

The present invention also provides a method for improving the transmission efficiency of a bitstream in a given network environment by newly defining the transmission priority for a bitstream.

According to an aspect of the present invention, there is provided an apparatus for transmitting a scalable bitstream to a client device after adjusting the bit-rate of an input scalable bitstream, including a bit adjuster extracting some layers from a number of frames contained in the scalable bitstream according to a scanning order; a streaming unit packetizing bits in the extracted layer to match a currently available bandwidth; and a bandwidth estimator estimating the currently available bandwidth.

The apparatus may further include a parser parsing the input scalable bitstream. The bit adjuster may extract the layer based on the result of parsing.

The apparatus may further include an index generator that generates index information containing position information on each frame and layer in the bitstream. Here, the bit adjuster may extract the layer using the index information.

The scalable video bitstream generated by a video encoder may be received through at least one of a network and a storage medium.

The scalable bitstream may be encoded using Fine Granular Scalability (FGS).

The index information may contain a start code, a bit position where data indicated by the index information is located in the bitstream, a frame number, and a layer number.

The scanning order may be determined by assigning priority in an ascending order from low to high layers in the unit number of frames and for layers with the same priority, a layer in a lower-numbered frame is given higher priority.

The streaming unit may split and packetize single layer data to fully utilize a bandwidth, and additional information indicating a portion of the single layer data where splitting occurs is added to the packetized bitstream.

According to another aspect of the present invention, there is provided a method for transmitting a scalable bitstream to a client device after adjusting the bit-rate of an input scalable bitstream, the method including estimating a currently available bandwidth, extracting some layers from a number of frames contained in the scalable bitstream according to a scanning order, and packetizing bits in the extracted layer to match the currently available bandwidth.

### BRIEF DESCRIPTION OF THE DRAWINGS

The above and other aspects of the present invention will become more apparent by describing in detail exemplary embodiments thereof with reference to the attached drawings in which:

FIG. 1 shows related art transmission priority used for a stream server to transmit a scalable bitstream;

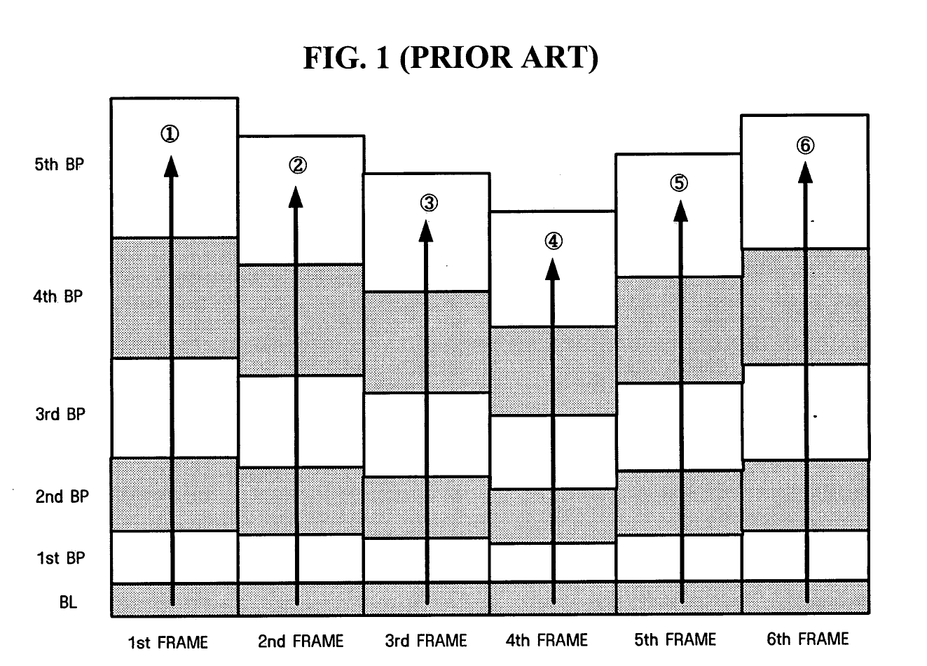

FIG. 2 illustrates a related art method for extracting a scalable bitstream according to a variable network bandwidth;

FIG. 3 is a block diagram of an apparatus for transmitting a scalable bitstream according to an exemplary embodiment of the present invention;

FIG. 4 shows an example of a difference coefficient of a DCT block;

FIG. 5 shows the content of an index file according to an exemplary embodiment of the present invention;

FIG. 6 illustrates an order in which scanning is performed for each layer in a number of frames according to an exemplary embodiment of the present invention;

FIG. 7 illustrates a scanning order after a lapse of time corresponding to a bit-rate allocated to the first frame shown in FIG. 6;

FIG. 8 shows an example of packetizing a bitstream into packets according to the scanning orders illustrated in FIGS. 6 and 7;

FIG. 9 is a graph illustrating a change in bandwidth in an actual network environment; and

FIG. 10 is a graph illustrating a change in bandwidth in a network artificially set to have a rapidly varying traffic.

### DETAILED DESCRIPTION OF THE EXEMPLARY EMBODIMENTS OF THE INVENTION

The present invention will now be described more fully with reference to the accompanying drawings, in which exemplary embodiments of the invention are shown. Advantages and features of the present invention and methods of accomplishing the same may be understood more readily by reference to the following detailed description of exemplary embodiments and the accompanying drawings. The present invention may, however, be embodied in many different forms and should not be construed as being limited to the embodiments set forth herein. Rather, these embodiments are provided so that this disclosure will be thorough and complete and will fully convey the concept of the invention to those skilled in the art. Like reference numerals refer to like elements throughout the specification.

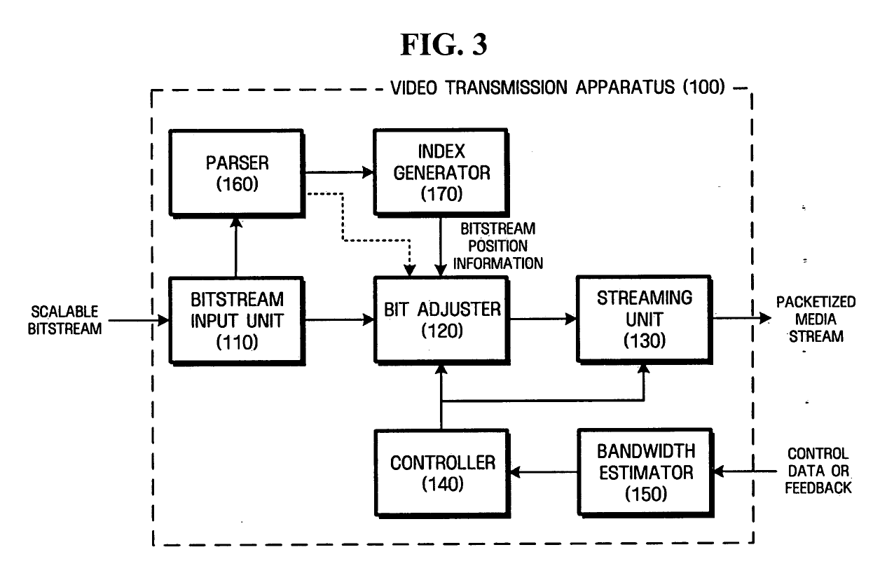

FIG. 3 is a block diagram of an apparatus 100 for transmitting a scalable bitstream according to an exemplary embodiment of the present invention. The apparatus 100 includes a bitstream input unit 110, a bit adjuster 120, a streaming unit 130, a controller 140, a bandwidth estimator 150, a parser 160, and an index generator 170.

The bitstream input unit 110 receives a scalable video bitstream generated by a video encoder. The scalable bitstream may be input through a network such as the Internet or an Intranet (former case) or a storage medium such as an optical disc or a magnetic disc (latter case). In the former case, the bitstream input unit 110 can be implemented as a network interface card and as an apparatus for reading the bitstream from the storage medium such as a DVD drive or CD-ROM drive, but not limited thereto.

The scalable bitstream may be generated by a video encoder using embedded quantization based on FGS coding, bit-plane coding, or wavelet coding. In FGS coding, a difference between an original input frame and a decoded base layer frame is calculated and decomposed into a plurality of bit-planes.

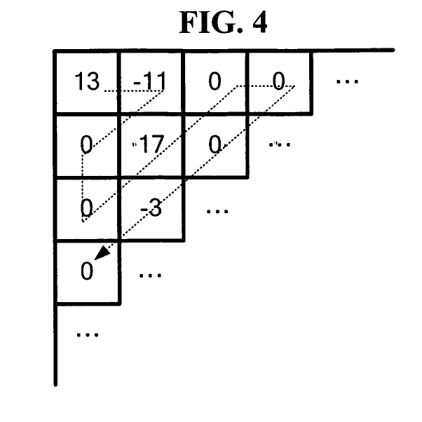

FIG. 4 shows an example of difference coefficients of a DCT block for an 8×8 DCT block. The omitted difference coefficients are all represented by 0. The difference coefficients may be arranged in a zig-zag scanning order, i.e., {+13, −11, 0, 0, +17, 0, 0, 0, −3, 0, 0, . . . }, and be decomposed into 5 bit planes, as shown in Table 1 below. Here, each bit plane has values that are coefficients of each numeral position when the difference coefficients are expressed by binary numbers.

TABLE 1

| | Value | | | | | | | | | |
|---|---|---|---|---|---|---|---|---|---|---|
| | +13 | −11 | 0 | 0 | +17 | 0 | 0 | 0 | −3 | 0 . . . |
| Bit plane 4 (2⁴) | 0 | 0 | 0 | 0 | 1 | 0 | 0 | 0 | 0 | 0 . . . |
| Bit plane 3 (2³) | 1 | 1 | 0 | 0 | 0 | 0 | 0 | 0 | 0 | 0 . . . |
| Bit plane 2 (2²) | 1 | 0 | 0 | 0 | 0 | 0 | 0 | 0 | 0 | 0 . . . |
| Bit plane 1 (2¹) | 0 | 1 | 0 | 0 | 0 | 0 | 0 | 0 | 1 | 0 . . . |
| Bit plane 0 (2⁰) | 1 | 1 | 0 | 0 | 1 | 0 | 0 | 0 | 1 | 0 . . . |

The enhancement layer represented by the bit planes is arranged sequentially in a descending order (e.g., highest-order bit plane 4 to lowest-order bit plane 0). To achieve signal-to-noise ratio (SNR) scalability by adjusting a bit-rate in a streaming server or scalable bitstream transmission apparatus, the enhancement layer is truncated from the lowest-order bit plane. If all bit planes except the bit plane 4 and the bit plane 3 are truncated, a video decoder will receive values {+8, −8, 0, 0, 16, 0, 0, 0, 0, . . . }.

Embedded quantization is suitable for use in a wavelet-based codec employing a wavelet transform for a spatial transform. For example but not by way of limitation, the embedded quantization may include encoding values above an initial threshold, encoding values above one-half the initial threshold, and repeating the above process by setting a new threshold equal to one-quarter the initial threshold. The embedded quantization is different from FGS at least in that the embedded quantization is performed using spatial redundancy. Examples of such embedded quantization algorithms include Embedded Zerotrees Wavelet Algorithm (EZW), Embedded ZeroBlock Coding (EZBC), Set Partitioning in Hierarchical Trees (SPIHT), but the present invention is not limited thereto.

By performing FGS coding or embedded quantization on texture data of a frame in this way, a user can arbitrarily truncate the texture data from the rear according to circumstances, thereby achieving SNR scalability.

Turning to FIG. 3, the parser 160 parses an input scalable bitstream on a frame-by-frame and layer-by-layer basis, and provides the result to the bit adjuster 120 or the index generator 170. In prior art, since a parser parses a bitstream whenever there is a request from the controller 140, the previously transmitted scalable bitstream needs to be parsed again when it is transmitted at a different bit-rate. However, according to an exemplary embodiment, the parser 160 performs parsing once on a specific bitstream, and the index generator 170 uses the result of parsing to generate an index file 10, thereby saving a system resource of the apparatus 100 for transmitting a scalable bitstream while allowing fast streaming.

The index generator 170 receives the result from the parser 160 and generates index information containing position information on each frame or layer in the bitstream. The index information can be stored in the form of a file or in a memory. The file index information can be stored as metadata or binary data. A bit adjuster 120 adaptively adjusts the bit-rate of the bitstream using the index information when there is a request from a client or video decoder.

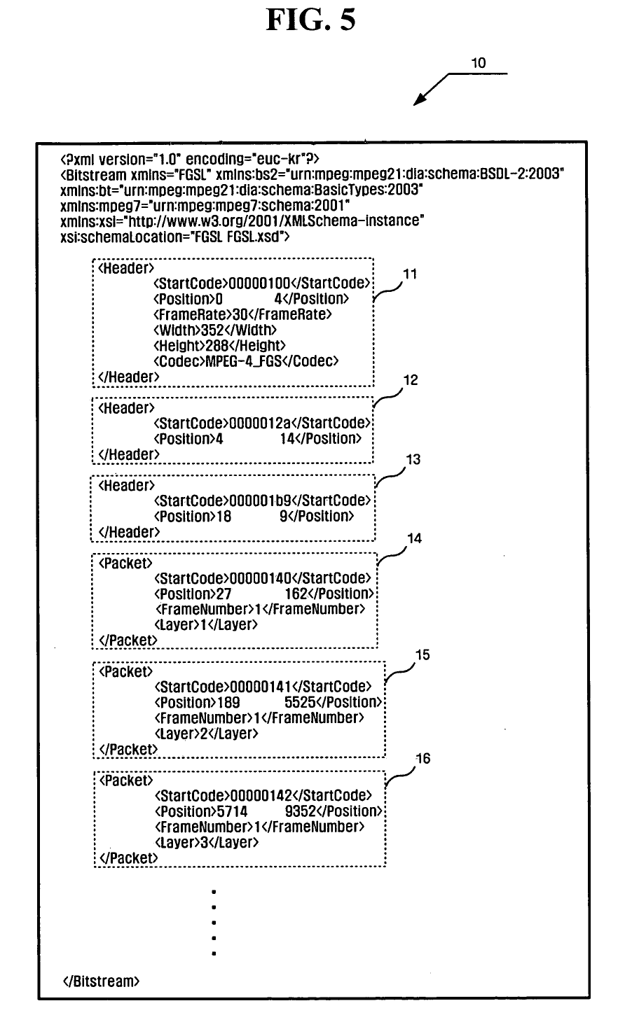

FIG. 5 shows an example of the index file 10 according to an exemplary embodiment of the present invention. While various related art efforts have been made to describe additional detailed information about a bitstream using the index file, the index file 10 of the present invention specifies position information on each frame and layer in the bitstream.

The index file 10 consists of a plurality of information units 11 through 16, each of which contains a plurality of elements (StartCode, Position, etc.). Each of the plurality of information units 11 through 16 may contain header information or packet information.

In the information unit 11 specifying header information, StartCode “00000100” contains start bits “000001” and a bit “00” specifying a Video Object (VO) header. Position indicates that the header information is recorded in bits 0 through 4 in the bitstream. The remaining portions of the information unit 11 specify that the bitstream has a frame rate of 30 Hz and dimensions of 352 (width)×288 (height) pixels and is encoded by MPEG-4 FGS coding.

In the information unit 12, “2a” in StartCode “0000012a” indicates that the information unit 12 is a Video Object Layer (VOL) header. In the information unit 13, “b9” in StartCode “000001b9” indicates that the information unit 13 is a FGS Video Object Plane (VOP) header.

Each of the information units 14 through 16 represents packet information and consists of StartCode, Position, FrameNumber, and Layer element. For example, when the scalable bitstream transmission apparatus 100 desires to extract a third layer in a first frame, bits 5714 through 9352 can be read according to values of Position in the information unit 16.

The bit adjuster 120 adjusts the bit-rate of a bitstream by extracting some layers from a unit number of frames contained in the bitstream according to a scanning order. Bits in the extracted layer are provided to the streaming unit 130.

The position information on each frame or layer provided by the parser 160 or the index generator 170 (hereinafter called “bit information”) is used to extract the layers to match a current bandwidth estimated by the bandwidth estimator 150. This process is performed by simply truncating parts of the bitstream.

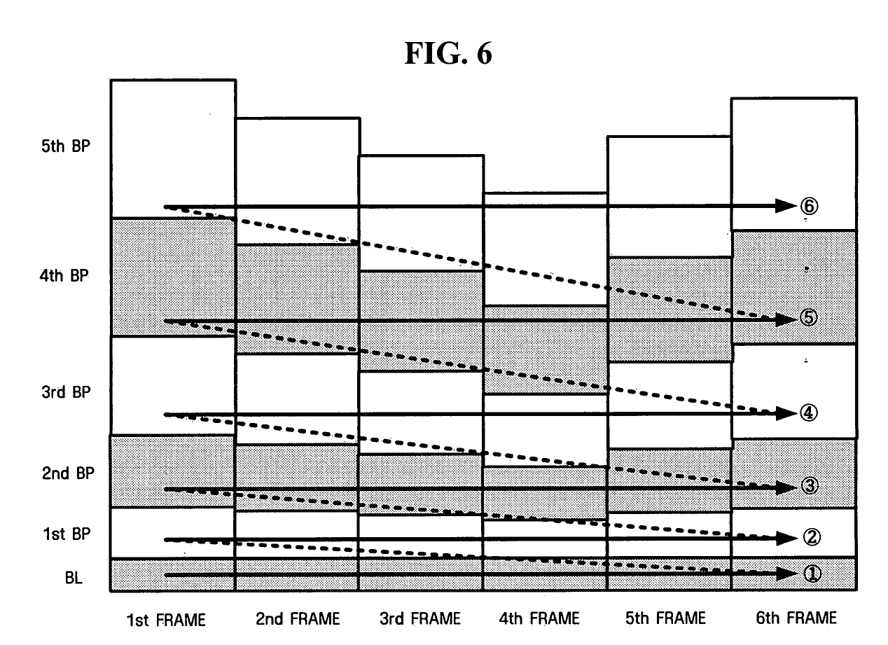

The bit adjuster 120 truncates a bitstream according to a different priority than defined in the related art. FIG. 6 illustrates a process of assigning priority for each layer during scanning according to an embodiment of the present invention. A related art priority for scanning is assigned in the order from a base layer to a high bit-plane of an enhancement layer in a current frame. On the other hand, according to the exemplary embodiment, a priority is allocated to each of layers in a number of frames (e.g. 6 frames as in FIG. 6).

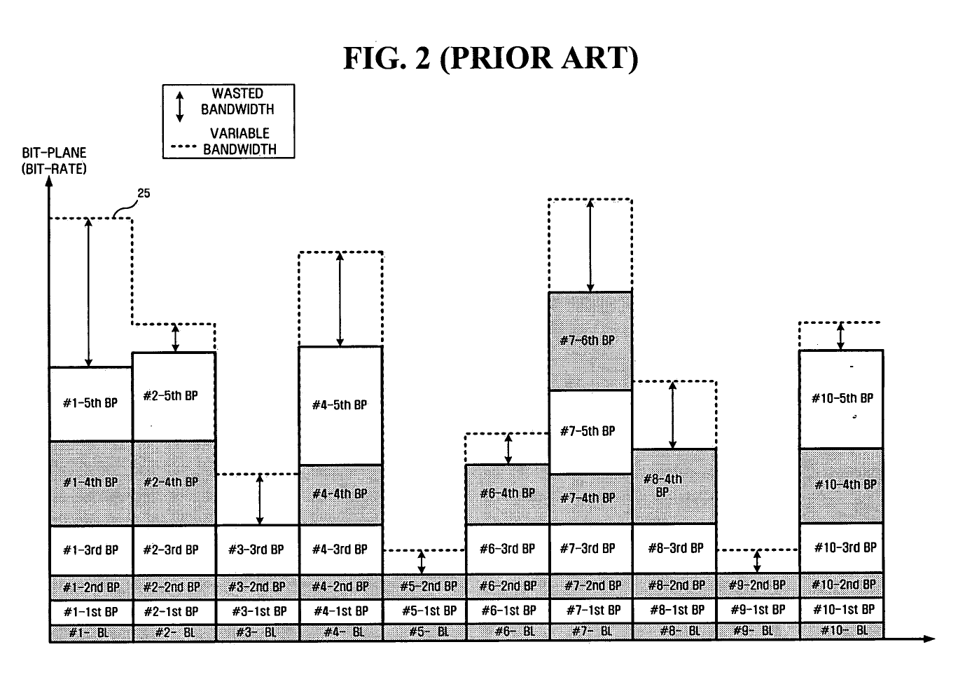

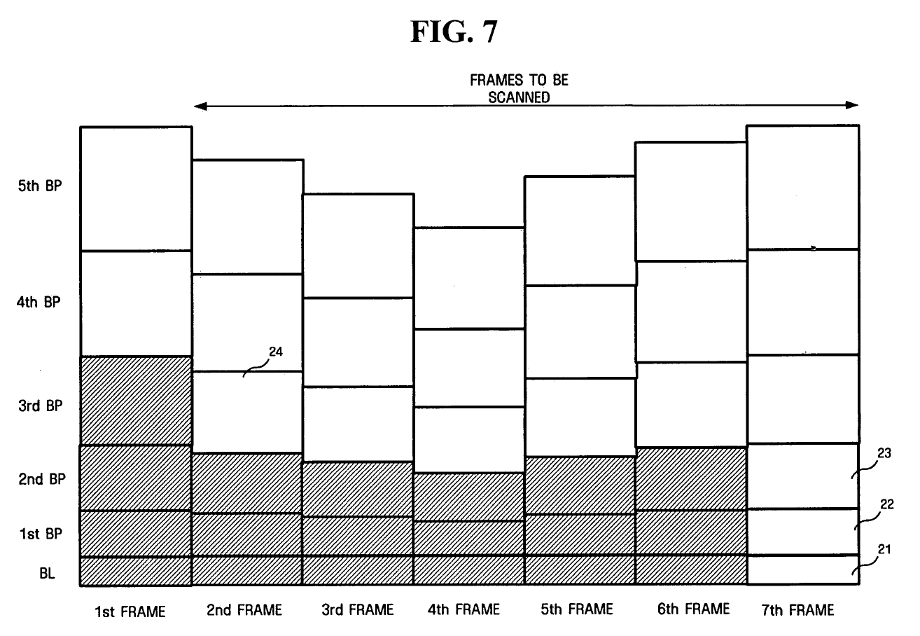

Referring to FIG. 6, a priority for scanning is assigned in an ascending order from low to high layer, regardless of a frame number. For layers with the same priority, a layer in a lower-numbered frame is given higher priority. By doing so, it is possible to prevent a rapid change in the quality of a reconstructed frame during streaming of a bitstream. Furthermore, since six base layer bitstreams are first transmitted, a video decoder can reconstruct six frames if a bandwidth temporarily drops to zero. However, after time corresponding to a bit-rate (25 of FIG. 2) allocated to the first frame lapses, the first frame is not scanned but is instead dropped while second through seventh frames will be scanned. FIG. 7 shows an example in which the first frame is dropped out of and a seventh frame is added to frames to be scanned. The second through seventh frames are scanned in the same order as shown in FIG. 6. In this case, when a shadowed portion has already been scanned and packetized, no further scanning is required for the shadowed portion. Thus, scanning is performed in the order of BL 21, first BP 22 and second BP 23 in the seventh frame and third BP 24 in the second frame.

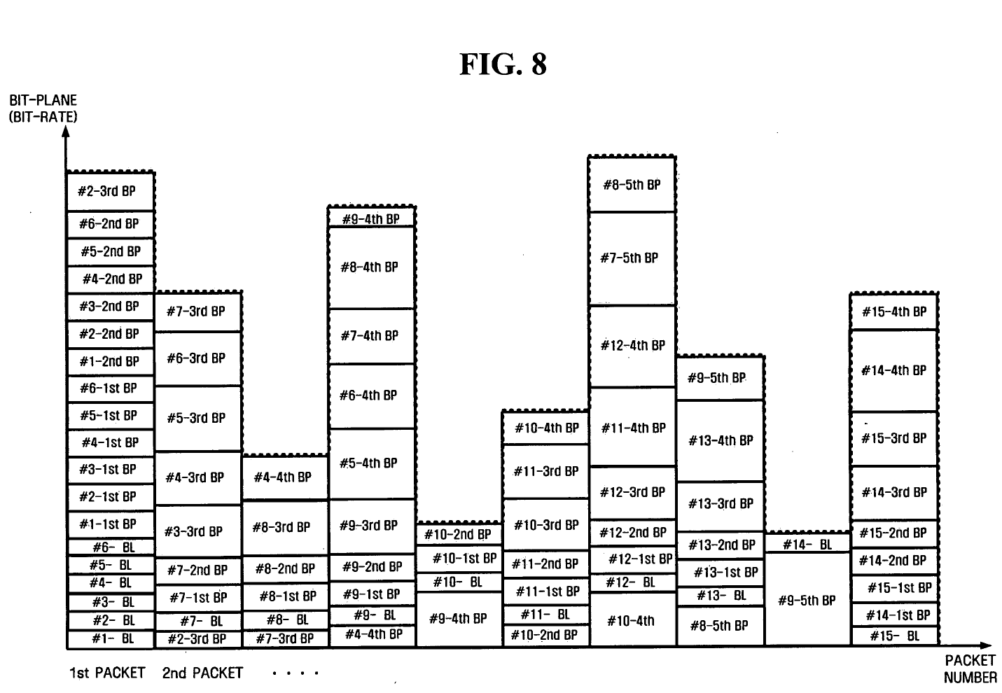

FIG. 8 shows an example of packetizing a bitstream into packets according to the scanning orders illustrated in FIGS. 6 and 7. An available bandwidth is fully utilized to packetize the bitstream into packets according to the scanning order. A single bit-plane can be split to become packets so that the available bandwidths are fully utilized. For example, #2-3rd BP is present at the beginning portion of a first packet and the ending portion of a second packet. When a single bit-plane is split in this way, information about a portion (offset) of the bit-plane where splitting occurs should be provided to a video decoder as additional information.

However, when a single bit-plane is not divisible, 100% of the available bandwidth cannot be used, but due to additional information, overhead can be reduced. In this case, because #2-3rd BP cannot be accommodated within the first packet, it will be scanned after #7-BL, #7-1st BP, and #7-2nd BP in the second packet are scanned.

While a related art FGS transmission control method requires only bit information about a current frame that can be obtained in real time by parsing the frame, the exemplary method requires bit information about a unit number of frames. To obtain the bit information, the parser 160 may parse a bitstream and the index generator 170 may generate an index file associated with the bit information.

Turning to FIG. 3, the streaming unit 130 packetizes bits in a layer extracted by the bit generator 120 according to the priority ordering scheme to match a currently available bandwidth, and sends the same to the video decoder. The video decoder analyzes the packetized bitstream and reconstructs layers in each frame. It will be obvious to those skilled in the art that the bitstream is packetized using MPEG-2 Transport Stream or Real-time Protocol (RTP) used for real-time streaming or other various streaming techniques. However, the present invention is not limited thereto.

The controller 140 controls a streaming service by monitoring network bandwidth, a client's request, and the status of the scalable bitstream transmission apparatus 100 in a comprehensive manner. The bandwidth estimator 150 directly measures the bandwidth of a network or receives the bandwidth measured by the client or network equipment to estimate an instantaneously varying bandwidth. For example, a target bit-rate may be determined using feedback information on currently available bit-rate received from a video decoder that has received a bitstream.

In FIG. 3, various components include, but are not limited to, software or hardware components, such as a Field Programmable Gate Arrays (FPGAs) or Application Specific Integrated Circuits (ASICs), which perform certain tasks. The components may advantageously be configured to reside on the addressable storage media and configured to execute on one or more processors. The functionality provided for in the components and modules may be combined into fewer components and modules or further separated into additional components and modules. Further, the exemplary embodiment may be provided in a computer-readable medium capable of performing a set of instructions that corresponds to the exemplary embodiments discussed herein.

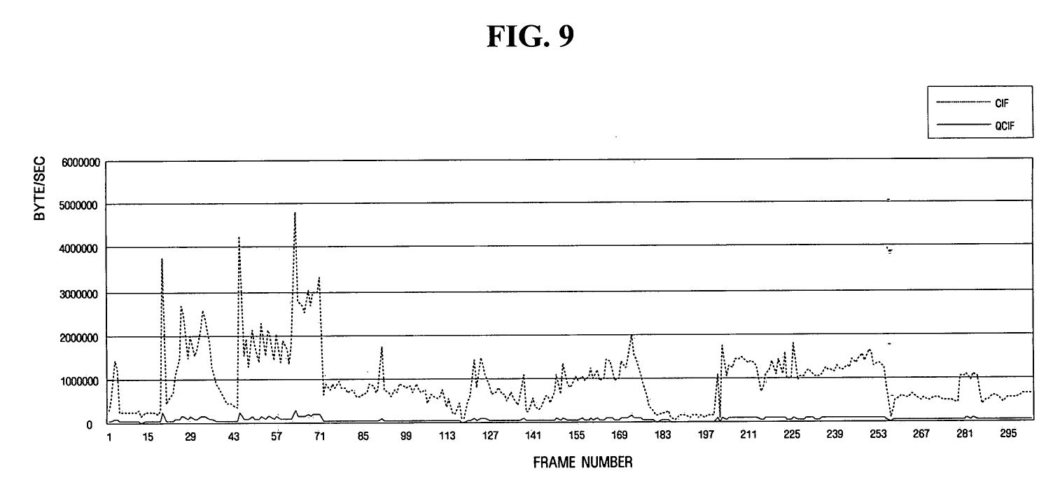

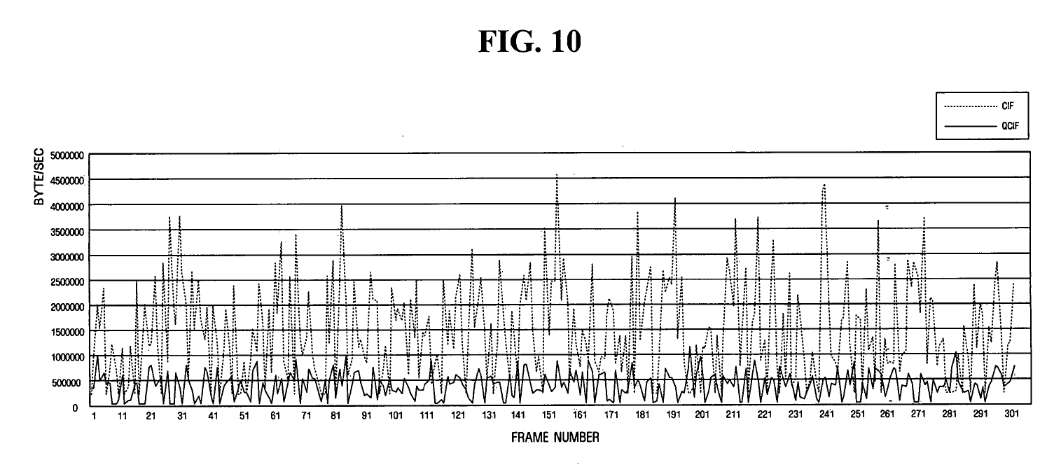

FIGS. 9 and 10 illustrate experimental environments according to the present invention. FIG. 9 is a graph illustrating a change in bandwidth in an actual network environment and FIG. 10 is a graph illustrating a change in bandwidth in a network artificially set to have a rapidly varying traffic. The experiments used “Coastguard” sequences in CIF and QCIF formats and each sequence is made up of 300 frames and has a frame rate of 30 frames per second (fps). An MPEG-4 standard codec was used for encoding/decoding the sequence.

Tables 2 and 3 show peak signal-to-noise ratio (PSNR) values measured on a frame reconstructed by a video decoder.

TABLE 2

| Average value (1^{st}-296-th frames) | | Prior art | Present invention |
|---|---|---|---|
| PSNR (dB) | CIF (1^{st}-183^{rd}) | Mean: 40.89 | Mean: 43.99 |
| | | Standard devia- | Standard devia- |
| | | tion: 7.5 | tion: 6.0 |
| | QCIF | Mean: 31.64 | Mean: 33.61 |
| | | Standard devia- | Standard devia- |
| | | tion: 2.4 | tion: 2.4 |
| Average bandwidth | CIF | 73.20% | 100% |
| efficiency | QCIF | 63.47% | 100% |

TABLE 3

| Average value (1^{st}-296-th frames) | | Prior art | Present invention |
|---|---|---|---|
| PSNR (dB) | CIF | Mean: 45.24 | Mean: 40.68 |
| | | Standard devia- | Standard devia- |
| | | tion: 9.3 | tion: 4.5 |
| | QCIF | Mean: 44.24 | Mean: 49.39 |
| | | Standard devia- | Standard devia- |
| | | tion: 10.8 | tion: 3.7 |
| Average bandwidth | CIF | 73.86% | 100% |
| efficiency | QCIF | 78.10% | 97.62% |

As evident from Tables 2 and 3, when the method of the present invention is used (i.e., the exemplary embodiment in which a layer can be split for packetization), an average bandwidth efficiency approaches 100%. Because the visual quality of a decoded frame does not rapidly change, consistent visual quality can be maintained across all reconstructed does frames (a small standard deviation). Conversely, the related art method suffers a significant change in visual quality of a reconstructed frame (a large standard deviation). The method of the exemplary embodiment exhibits average PSNR values that are about 2-4 dB higher than that provided by the related art method.

The exemplary embodiment can reduce the overhead of repetitive parsing of a scalable bitstream using separate file index information as well as the bitstream.

The exemplary embodiment can efficiently utilize an instantaneously varying bandwidth by performing video streaming using a scanning order.

The exemplary embodiment can also improve the visual quality of a video stream and reduces a flickering effect caused by a change in visual quality resulting from a bandwidth change.

While the exemplary embodiment has been particularly shown and described with reference to exemplary embodiments thereof, it will be understood by those of ordinary skill in the art that various changes in form and details may be made therein without departing from the spirit and scope of the present invention as defined by the following claims. Therefore, it is to be understood that the above-described embodiments have been provided only in a descriptive sense and will not be construed as placing any limitation on the scope of the invention.

What is claimed is:

1. An apparatus for transmitting a scalable bitstream to a client device after adjusting the bit-rate of an input scalable bitstream, the apparatus comprising:
a bit adjuster that extracts a plurality of layers from a number of frames contained in the scalable bitstream based on a scanning order;
a streaming unit that packetizes bits in the extracted layer to match a currently available bandwidth; and
a bandwidth estimator that estimates the currently available bandwidth.

2. The apparatus of claim 1, further comprising a parser that parses the input scalable bitstream,
wherein the bit adjuster extracts one of the layers based on the result of parsing.

3. The apparatus of claim 1, further comprising an index generator that generates index information containing position information on each of said frames and each of said layers in the bitstream,
wherein the bit adjuster extracts the layer using the index information.

4. The apparatus of claim 3, wherein the index information is generated and stored as one of binary data and metadata.

5. The apparatus of claim 3, wherein the index information contains a start code, a bit position where data indicated by the index information is located in the bitstream, a frame number, and a layer number.

6. The apparatus of claim 5, wherein when the layer number indicating a base layer is represented by 0 (zero).

7. The apparatus of claim 1, wherein the scalable video bitstream generated by a video encoder is received through at least one of a network and a storage medium.

8. The apparatus of claim 1, wherein the scalable bitstream is encoded using Fine Granular Scalability (FGS).

9. The apparatus of claim 1, wherein the scalable bitstream is encoded using embedded quantization.

10. The apparatus of claim 1, wherein the scanning order is determined by assigning priority in an ascending order from low to high ones of said layers in the number of frames and for ones of said layers with the a common priority, one of said layers in a lower-numbered one of said frames is given higher priority.

11. The apparatus of claim 10, wherein said priority for scanning is allocated among all of said layers excluding ones of said layers already scanned and packetized.

12. The apparatus of claim 1, wherein the streaming unit splits and packetizes single layer data to fully utilize a bandwidth, and information indicating a portion of the single layer data where splitting occurs is added to the packetized bitstream.

13. The apparatus of claim 1, wherein the bandwidth estimator receives feedback information on a currently available bit-rate received from the client and estimates a target transmission bit-rate using the feedback information.

14. A method for transmitting a scalable bitstream to a client device after adjusting the bit-rate of an input scalable bitstream, the method comprising:
estimating a currently available bandwidth;
extracting a plurality of layers from a number of frames contained in the scalable bitstream according to a scanning order; and
packetizing bits in the extracted layer to match the currently available bandwidth.

15. The method of claim 14, further comprising generating index information containing position information on each of said frames and each of said layers in the bitstream.

16. The method of claim 15, wherein the index information contains a start code, a bit position where data indicated by the index information is located in the bitstream, a frame number, and a layer number.

17. The method of claim 14, wherein the scanning order is determined by assigning priority in an ascending order from low to high layers in the unit number of frames and for ones of said layers with the same priority, a layer in a lower-numbered one of said frames is given higher priority.

18. A recording medium having a computer readable program for executing a method for transmitting a scalable bitstream to a client device after adjusting the bit-rate of an input scalable bitstream, the method comprising:
estimating a currently available bandwidth;
extracting a plurality of layers from a number of frames contained in the scalable bitstream according to a scanning order; and
packetizing bits in the extracted layer to match the currently available bandwidth.

19. The recording medium of claim 18, wherein the method further comprises generating index information containing position information on each of said frames and each of said layers in the bitstream, wherein the index information contains a start code, a bit position where data indicated by the index information is located in the bitstream, a frame number, and a layer number.

20. The recording medium of claim 18, wherein the scanning order is determined by assigning priority in an ascending order from low to high layers in the unit number of frames and for ones of said layers with the same priority, a layer in a lower-numbered one of said frames is given higher priority.
